(19) United States
(12) Patent Application Publication
(10) Pub. No.: US 2012/0136687 A1
(43) Pub. Date: May 31, 2012

(54) System and Method for CAPA Process Automation

(75) Inventors: Wei Tang, Shanghai (CN); Bo Zhang, Shanghai (CN); Ya Wang, Shanghai (CN)

(73) Assignee: SAP AG, Walldorf (DE)

(21) Appl. No.: 12/955,606

(22) Filed: Nov. 29, 2010

(51) Int. Cl. G06Q 10/00

(52) U.S. Cl. 705/7.15; 705/7.28; 705/7.13

(57) ABSTRACT

The present disclosure involves systems, products, and methods for automatically generating a CAPA plan. One method includes operations for identifying an issue associated with a business system; identifying a set of information associated with the issue including a plurality of evaluation factors defining the issue; identifying a set of weighting values associated with the issue, each weighting values associated with a particular evaluation factor; evaluating the issue based on the plurality of evaluation factors combined with the corresponding weighting value, determining at least one root cause for the issue based on the evaluation results, identifying at least one corrective or preventive action based at least in part on the at least one determined root cause for the issue, and automatically generating the CAPA plan including the at least one determined root cause and the at least one identified corrective or preventive action associated with the issue.

### TECHNICAL FIELD

The present disclosure relates to systems and methods for automating corrective and preventive action (CAPA) processes.

### BACKGROUND

Good manufacturing practice (GMP) is part of a quality system covering the manufacture and testing of active pharmaceutical ingredients, diagnostics, foods, pharmaceutical products, and medical devices. GMPs provide guidelines that outline the aspects of production and testing that can impact the quality of a product. Generally, GMP guidelines are a series of general principles that must be observed during manufacturing. Some example guidelines include:
Manufacturing processes are clearly defined and controlled. All critical processes are validated to ensure consistency and compliance with specifications.
Manufacturing processes are controlled, and any changes to the processes are evaluated. Changes that have an impact on the quality of the product are validated as necessary.
Instructions and procedures are written in clear and unambiguous language.
Operators are trained to carry out and document procedures.
Records are made, manually or by instruments, during manufacture that demonstrate that all the steps required by the defined procedures and instructions were in fact taken and that the quantity and quality of the drug was as expected. Deviations are investigated and documented.
Records of manufacture (including distribution) that enable the complete history of a batch to be traced are retained in a comprehensible and accessible form.
The distribution of the drugs minimizes any risk to their quality.
A system is available for recalling any batch of drug from sale or supply.
Complaints about marketed drugs are examined, the causes of quality defects are investigated, and appropriate measures are taken with respect to the defective drugs and to prevent recurrence.

GMP guidelines are not prescriptive instructions on how to manufacture products. They are a series of general principles that must be observed during manufacturing. When a company is setting up its quality program and manufacturing process, there may be many ways it can fulfill GMP requirements. It is the company's responsibility to determine the most effective and efficient quality process.

Corrective and preventive action (“CAPA”) is a regulatory concept within GMP. CAPA focuses on the systematic investigation of discrepancies (failures and/or deviations) in an attempt to correct any issues and prevent their future recurrence. To ensure that corrective and preventive actions are effective, the systematic investigation of the failure incidence is pivotal in identifying the corrective and preventive actions undertaken. CAPA focuses on investigating, understanding, and correcting discrepancies while attempting to prevent their recurrence.

### SUMMARY

The present disclosure involves systems, products, and methods for automatically generating a CAPA plan. One method includes operations for identifying an issue associated with a business system; identifying a set of information associated with the issue including a plurality of evaluation factors defining the issue; identifying a set of weighting values associated with the issue, each weighting values associated with a particular evaluation factor; evaluating the issue based on the plurality of evaluation factors combined with the corresponding weighting value, determining at least one root cause for the issue based on the evaluation results, identifying at least one corrective or preventive action based at least in part on the at least one determined root cause for the issue, and automatically generating the CAPA plan including the at least one determined root cause and the at least one identified corrective or preventive action associated with the issue.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example system for automating the generation of a CAPA plan.

FIG. 2 is a flowchart of an example method for automatically generating a CAPA plan and completing the actions associated therewith.

FIG. 3 is a flowchart of an example method for executing an automatically generated CAPA plan by one or more persons associated with the plan.

FIG. 4 is a data model of database tables associated with an example implementation of an automatic CAPA generation system.

FIGS. 5A-5C illustrate example data associated with several of the tables included in FIG. 4, the data representing example input and output associated with a particular implementation, such as the example system of FIG. 1.

### DETAILED DESCRIPTION

Life sciences organizations, food and drug manufacturers, and other companies deal with a broad range of industry-specific regulatory issues in addition to their standard corporate governance, risk, and compliance demands. In some industries, including those in biotechnology, pharmaceutical, medical devices, and life sciences, regulatory compliance is a key component of their businesses. As these companies focus on their core business and competencies, simultaneous pressure to comply with demanding regulatory requirements and the continuous increase in quality and safety expectations are provided. The solutions of the present disclosure provide an integrated risk-based approach and a centralized and unified compliance management platform to enable these companies to proactively comply with regulatory (such as the Food and Drug Administration (FDA)) regulations on an ongoing basis.

In most cases, the generation of a CAPA process and plan is performed manually by one or more individuals within a particular organization once an issue is identified. In the present disclosure, systems and methods for automatically identifying the root causes of a particular manufacturing or other related issue, as well as one or more corrective and/or preventive actions associated with the issue to be performed, are determined. In some instances, data on one or more manufacturing and other production processes and applications may be received at a centralized CAPA system. Using that data, the centralized CAPA system may identify one or more root causes of the issue and identify one or more corrective and/or preventive actions to be performed to solve the current issue and prevent its recurrence. In some instances, a CAPA plan may be generated, where the CAPA plan defines a set of actions (corrective, preventive, or both) to be performed, including a determination and assignment of one or more persons or entities to perform those actions. The centralized CAPA system can be communicably coupled to at least one CAPA-related system and a plurality of associated users. Through these connections, the centralized CAPA system can collect and monitor the various actions included in the CAPA plan, and further manage the completion of the CAPA plan and its actions. In some instances, the centralized CAPA system can include functionality capable of meeting other regulatory requirements, such as those of 21 C.F.R. 11, which include providing audit trails associated with the set of actions performed and to be performed, a document management service for maintaining documents related to the CAPA process, and methods of using and applying electronic signatures.

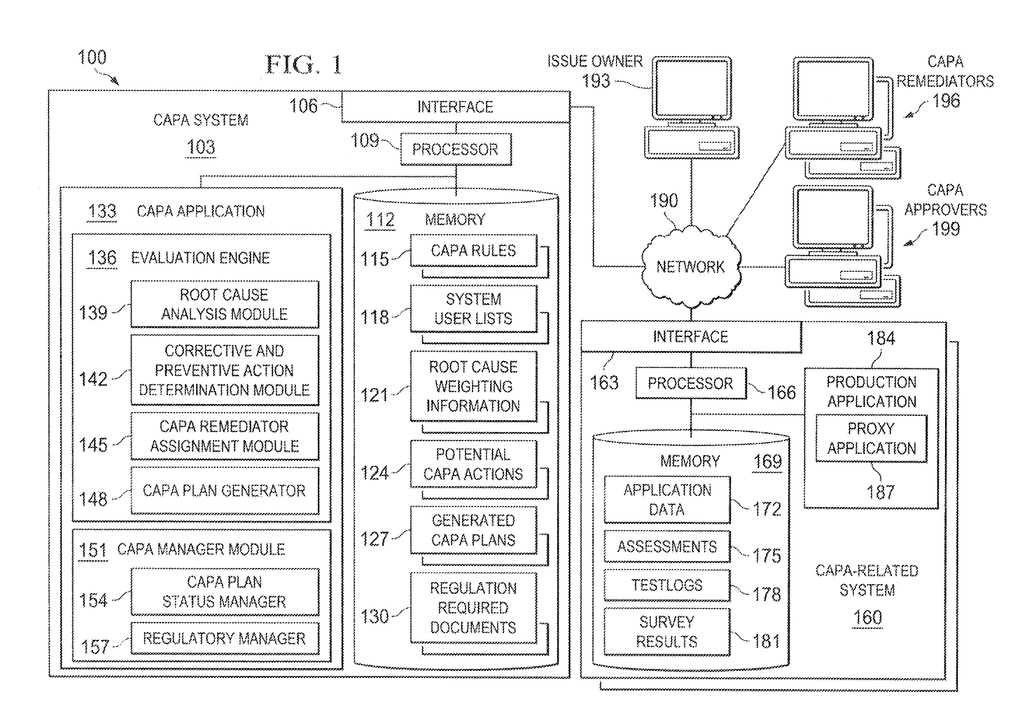

Turning to the illustrated example, FIG. 1 illustrates an example environment or system 100 for automating the generation of a CAPA plan and performing a set of CAPA actions and processes. The illustrated system 100 includes, or is communicably coupled with, a CAPA system 103, one or more CAPA-related systems 160, an issue owner 193, one or more CAPA remediators 196, and one or more CAPA approvers 199, at least some of which communicate across a network 190. In general, system 100 depicts an example configuration of a system capable of receiving issue information, including assessment data, test logs, survey results, and other information associated with an issue in a manufacturing process and, in response, determining at least one root cause of the issue and automatically developing a CAPA plan for execution.

In general, the CAPA system 103 is any server that stores a CAPA application 133 operable when executed to perform at least a portion of the operations associated with generating a CAPA plan and managing the CAPA process. The CAPA application 133 may be executed, at least in part, via requests received from and responses sent to users or clients within and/or communicably coupled to the illustrated system 100 of FIG. 1. In some instances, the received requests may include information automatically provided by one or more CAPA-related systems 160, such as those directly involved or associated with the manufacturing of a product, drug, food, or related item. In some instances, the CAPA system 103 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the CAPA system 103 may be a dedicated system and/or server solely associated with the various CAPA processes, while in other instances, the CAPA system 103 may be a part of or associated with one or more production or manufacturing systems, including, but not limited to, one of the CAPA-related systems 160. In some instances, the CAPA system 103 may comprise a web server or be communicably coupled with a web server, where the CAPA application 133 represents, at least in part, one or more web-based applications accessed and executed via network 190 by the clients and use of the system 100 (including the issue owner 193, one or more CAPA remediators 196, and/or one or more CAPA approvers 199) to perform the programmed tasks or operations associated with the CAPA application 133.

At a high level, the CAPA system 103 comprises an electronic computing device operable to receive, transmit, process, store, or manage data and information associated with the environment 100. The CAPA system 103 illustrated in FIG. 1 can receive application requests or data from one or more clients (e.g., the issue owner 193, one or more CAPA remediators 196, and/or one or more CAPA approvers 199), one or more CAPA-related systems 160 (or programs associated with or executed on those systems 160, such as a production application 184 or a proxy application 187) and respond to the received requests by processing said requests in the CAPA application 133. The CAPA system 103 can send any appropriate response from the CAPA application 133 back to the originating application or system. Additionally, the CAPA application 133 can analyze the information received and subsequently generate all or a portion of a responsive CAPA plan. In those instances, one or more of the users or clients associated with the system 100 may be contacted or notified of the newly generated CAPA plan. Further, each user or client associated with the CAPA plan may be provided with the entirety of the CAPA plan, while in other instances, only portions of the CAPA plan relevant to them (i.e., the specific corrective or preventive actions assigned to a particular user). In addition to requests from the components illustrated in FIG. 1, requests and information associated with the CAPA application 133 may also be sent from internal users, external or third-party customers, and other automated applications, as well as any other appropriate entities, individuals, systems, or computers not explicitly illustrated in FIG. 1.

As used in the present disclosure, the term “computer” is intended to encompass any suitable processing device. For example, although FIG. 1 illustrates the CAPA system 103 as a single server, system 100 can be implemented using two or more servers for the CAPA system 103, as well as computers other than servers, including a server pool. Indeed, CAPA system 103 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated CAPA system 103 may be adapted to execute any operating system, including Linux, UNIX, Windows, Mac OS, or any other suitable operating system. According to one embodiment, the CAPA system 103 may also include or be communicably coupled with a mail server.

In the present implementation, and as shown in FIG. 1, the CAPA system 103 includes a processor 109, an interface 106, a memory 112, and a CAPA application 133. The interface 106 is used by the CAPA system 103 for communicating with other systems in a client-server or other distributed environment (including within system 100) connected to the network 190 (e.g., issue owner 193, one or more CAPA remediators 196, one or more CAPA approvers 199, one or more CAPA-related systems 160, as well as other systems communicably coupled to the network 190 not shown in FIG. 1). Generally, the interface 106 comprises logic encoded in software and/or hardware in a suitable combination and operable to communicate with the network 190. More specifically, the interface 106 may comprise software supporting one or more communication protocols associated with communications such that the network 190 or interface's hardware is operable to communicate physical signals within and outside the illustrated environment 100.

Although not illustrated in FIG. 1, the CAPA system 103 may also include a user interface, such as a graphical user interface (GUI). The GUI can comprise a graphical user interface operable to, for example, allow the user of the CAPA system 103 to interface with at least a portion of the platform for any suitable purpose, such as creating, preparing, requesting, or analyzing data, as well as viewing and accessing CAPA plans, received data, and other information associated with the CAPA application 133. Generally, the GUI provides the particular user with an efficient and user-friendly presentation of business data provided by or communicated within the system. The GUI may comprise a plurality of customizable frames or views having interactive fields, pull-down lists, and buttons operated by the user. For example, the GUI may provide interactive elements that allow a user to enter or select elements of business process instances in the GUI. More generally, the GUI may also provide general interactive elements that allow a user to access and utilize various services and functions of CAPA application 133, including any modifications and corrections that may be made to customizable data and other information associated with the CAPA application 133 or one or more generated CAPA plans 127 or potential CAPA actions 124. The GUI is often configurable, supports a combination of tables and graphs (bar, line, pie, status dials, etc.), and is able to build real-time portals, where tabs are delineated by key characteristics (e.g., site or micro-site). Therefore, the GUI contemplates any suitable graphical user interface, such as a combination of a generic web browser, intelligent engine, and command line interface (CLI) that processes information in the platform and efficiently presents the results to the user visually.

Generally, example CAPA system 103 may be communicably coupled with a network 190 that facilitates wireless or wireline communications between the components of the overall system 100 (i.e., between the CAPA system 103 and one or more of the CAPA-related systems 160, as well as between the CAPA system 103 and one or more of the users or other clients), as well as with any other local or remote computer, such as additional clients, servers, or other devices communicably coupled to network 190 but not illustrated in FIG. 1. In the illustrated environment, the network 190 is depicted as a single network in FIG. 1, but may be a continuous or discontinuous network without departing from the scope of this disclosure, so long as at least a portion of the network 190 may facilitate communications between senders and recipients. The network 190 may be all or a portion of an enterprise or secured network, while in other instances, at least a portion of the network 190 may represent a connection to the Internet. In some instances, a portion of the network 190 may be a virtual private network (VPN), such as, for example, the connection between the CAPA-related system 160 and the CAPA system 103. Further, all or a portion of the network 190 can comprise either a wireline or wireless link. Example wireless links may include 802.11a/b/g/n, 802.20, WiMax, and/or any other appropriate wireless link. In other words, the network 190 encompasses any internal or external network, networks, sub-network, or combination thereof operable to facilitate communications between various computing components inside and outside the illustrated system 100. The network 190 may communicate, for example, Internet Protocol (IP) packets, Frame Relay frames, Asynchronous Transfer Mode (ATM) cells, voice, video, data, and other suitable information between network addresses. The network 190 may also include one or more local area networks (LANs), radio access networks (RANs), metropolitan area networks (MANs), wide area networks (WANs), all or a portion of the Internet, and/or any other communication system or systems at one or more locations. The network 190, however, is not a required component of the present disclosure.

As illustrated in FIG. 1, CAPA system 103 includes a processor 109. Although illustrated as a single processor 109 in FIG. 1, two or more processors may be used according to particular needs, desires, or particular embodiments of environment 100. Each processor 109 may be a central processing unit (CPU), a blade, an application specific integrated circuit (ASIC), a field-programmable gate array (FPGA), or another suitable component. Generally, the processor 109 executes instructions and manipulates data to perform the operations of CAPA system 103 and, specifically, the CAPA application 133 and its subcomponents included on or within the CAPA system 103. Specifically, the CAPA system's processor 109 executes the functionality required to receive data and requests from the communicably coupled components of example system 100, analyze the data and requests received, update various sets of information through the system 100, and response, as needed, to those components. The processor 109 may further execute instructions associated with other functionality performed by the CAPA system 103.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, processor 109 executes the CAPA application 133 and its associated operations on the CAPA system 103.

At a high level, the CAPA application 133 is any application, program, module, process, or other software that may execute, change, delete, generate, or otherwise manage information according to the present disclosure, particularly in response to information and notifications associated with issues in a manufacturing environment and/or process, including information received from one or more CAPA-related systems 160. In FIG. 1, the CAPA application 133 is illustrated as a single application within the CAPA system 103. In some instances, however, the CAPA application 133 may be a combination of applications or software, sometimes executing on a plurality of systems, performing various portions of the functionality associated with the CAPA application 133. In some instances, a portion of the CAPA application 133 may be executed remotely, either at a CAPA-related system 160 or at another location communicably coupled to the CAPA system 103. In some instances, system 100 may implement the CAPA application 133 as part of a composite application. For example, portions of the composite application may be implemented as Enterprise Java Beans (EJBs) or design-time components, and may have the ability to generate run-time implementations into different platforms, such as J2EE (Java 2 Platform, Enterprise Edition), ABAP (Advanced Business Application Programming) objects, or Microsoft's .NET, among others. Additionally, portions of the CAPA application 133 may be represented as web-based applications accessed and executed by remote clients or systems via the network 190 (e.g., through the Internet). Further, while illustrated as internal to the CAPA system 103, one or more processes associated with the CAPA application 103 may be stored, referenced, or executed remotely. For example, a portion of the CAPA application 133 may be a web service associated with the application that is remotely called, while another portion of the CAPA application 133 may be an interface object or agent bundled for processing at a remote system (such as a CAPA remediator 196 or a CAPA-related system 160). Moreover, any or all of the CAPA application 133 may be a child, sub-module, or portion of another software module or enterprise application (not illustrated) without departing from the scope of this disclosure. Some or all of the CAPA application 133 may be executed by a user or operator working directly at the CAPA system 103, as well as remotely at a communicably coupled client or system.

As illustrated, the CAPA application 133 includes a plurality of sub-components and modules. For example, the CAPA application 133 is illustrated as containing two primary components: an evaluation engine 136 and a CAPA manager module 151. In general, the evaluation engine 136 receives data and other inputs from components of the system 100 associated with the CAPA application 133. For example, manufacturing-related data and other information can be received from the CAPA-related system 160, including raw application data 172 defining information about the operations of the CAPA-related system 160, assessment information 175 associated with one or more assessments performed by or on the CAPA-related system 160, test logs 178 generated in response to testing of a portion of the CAPA-related system 160, as well as survey results 181 completed by one or more users associated with the CAPA-related system 160. In some instances, the assessment data 175, test logs 178, and survey results 181 may be associated with one or more regulatory controls or tests performed in accordance with the applicable laws and regulations of the jurisdiction(s) associated with the CAPA-related system 160. If the CAPA-related system 160 is associated with the United States, one or more FDA-based controls or tests may be run with the results and data being provided to the CAPA application 133.

In some instances, the CAPA application 133 may include a module for retrieving some or all of this information from the CAPA-related system 160. As illustrated in FIG. 1, the proxy application 187 represents a remotely executed portion of the CAPA application 133 executing at a particular CAPA-related system 160. The proxy application 187 can collect the relevant information associated with one or more production applications 184 and send that information back to the CAPA application 133 for processing. In some instances, the proxy application 187 may be considered passive, in that it merely sends or transmits a copy of the information generated at its CAPA-related system 160 back to the CAPA application 133 without further processing. In other instances, however, the proxy application 187 may be considered active, in that it performs additional processing on the information collected prior to returning the information to the CAPA application 133. In some instances, the proxy application 187 may perform additional portions or functionality otherwise associated with the CAPA application 133.

The evaluation engine 136 of the CAPA application 133 performs various functions to analyze the information received from the CAPA-related system 160 (and/or the proxy application 187). The evaluation engine 136 is illustrated as including four additional sub-modules: a root cause analysis module 139, a corrective and preventive action determination module 142, a CAPA plan generator 148, and a CAPA remediator assignment module 145. In some instances, the evaluation engine 136 may initially determine whether or not an issue has arisen, such as by evaluating a set of data and information (such as assessments and test logs) received from the CAPA-related system 160. If no issues are identified, the evaluation engine 136 may continue to collect and analyze the data. In still other instances, one or more users associated with the CAPA-related system 160 can manually identify or flag an issue, such as by submitting an issue ticket or other problem notification-related action.

If an issue is identified, the collected set of information may be passed to the root cause analysis module 139 in order to determine the one or more root causes of the issue. The root cause analysis module 139 may use any combination of relevant data to determine the causes of the issue, including the priority and type of the issue, the received assessment and test log results, the control or testing type (i.e., the FDA control from which the issue was determined), the business process type associated with the identified issue, the attributes of the organization to which the process is assigned (or which performed the control or test), as well as any other suitable information. Each factor considered can be provided a corresponding weight, the weights used as multipliers to make certain factors more or less important in determining the root cause. The weighting for each factor, as well as the factors considered, can be changed by modifying one or more sets of information associated with the evaluation engine 136. For example, FIG. 1 illustrates a set of root cause weighing information 121 stored in memory 112 that defines the weighting for particular factors in an analysis. Weighting for one or more profiles may be stored with the root cause weighting information 121 and applied as appropriate by the evaluation engine 136 and root cause analysis module 139. Similarly, a set of information defining which factors to consider in determining the appropriate CAPA actions may also be present in the memory 112, illustrated here as a set of CAPA rules 115.

The corrective and preventive action determination module 142 uses the information associated with the CAPA-related system 160, its production application(s) 184, the identified issue(s), and the identified root cause(s) to determine one or more corrective and preventive actions that should be included in a CAPA plan in order to correct the pending issue and to prevent the issue from occurring again in the future. In some instances, the corrective and preventive action determination module 142 can use the collected and generated information to search a set of potential CAPA actions 124 stored in memory 112. Based on the identified root causes and the set of information regarding the issue and the associated process or application, the corrective and preventive action determination module 142 can access the potential CAPA actions 124 and identify and/or assign one or more CAPA actions to be included in a CAPA plan. The corrective and preventive actions included in a CAPA plan may include modifications to system procedures, changes to system settings and configurations, reviews of one or more processes, additional investigations, and other suitable actions corrective and/or preventive actions.

The CAPA plan generator 148 is used to generate the CAPA plan. The root cause(s) and the assigned CAPA actions can be included in the CAPA plan by the CAPA plan generator. In some instances, the CAPA plan generated by the CAPA plan generator 148 can be based on a CAPA plan template. The CAPA plan template may also be used so that the generated CAPA plans meet any requirements defined by the relevant governing jurisdiction associated with the CAPA-related system 160 and/or the CAPA system 103. In some instances, the generated CAPA plan may be represented or stored as an eXtensible Markup Language (XML) file, a text file, a comma-delimited text file, a spreadsheet, or any other suitable file and/or format. Each CAPA plan can be included within a set of generated CAPA plans 127 stored at memory 112. Each stored generated CAPA plan 127 can be associated with a particular issue and/or CAPA-related system 160.

For each generated CAPA plan, the CAPA remediator assignment module 145 identifies one or more users, individuals, or entities for each of the determined correction and/or preventive actions included in the CAPA plan. The CAPA remediator assignment module 145 can access one or more system user lists 118 stored in memory 112. The system user lists 118 can define various roles of users and individuals within or associated with a particular CAPA-related system 160, as well as for particular processes and applications associated therewith. By determining the users, individuals, or entities associated with a particular action, the CAPA remediator assignment module 145 can assign users to particular actions within the CAPA plan, which may then be reflected in the generated CAPA plan (i.e., by the CAPA plan generator 148 modifying or updating the generated CAPA plan). In some instances, the CAPA plan generator 148 may not generate the CAPA plan until the CAPA remediator assignment module 145 has identified users or entities to perform each of the associated actions. The CAPA remediator assignments can be modified by an issue owner 193 associated with the CAPA plan. Each CAPA remediator is then responsible for performing the corrective and/or preventive actions assigned to them.

Once the CAPA plan is generated for a particular issue, the CAPA manager module 151 of the CAPA application 133 can monitor the progress and status of the various assigned actions and the associated CAPA remediators 196. For example, the CAPA manager module 151 and its sub-modules can determine, either automatically or based on information received through one or more of the CAPA remediators 196, when the corrective and/or preventive actions included within the CAPA plan are performed by the various CAPA remediators 196. The CAPA plan status manager 154 can prepare and exchange messages with one or more of the CAPA remediators 196 to receive status information on the actions of the CAPA plan, as well as retrieve or request updated system information from the CAPA-related system 160 to determine if the assigned actions have been performed. In some instances, the CAPA plan status manager 154 can prepare and send surveys to one or more users associated with the issue and/or the CAPA-related system 160 for completion. Based on the results of the surveys, the CAPA plan status manager 154 can determine if the actions have been completed, and whether the actions are successful. The CAPA plan status manager 154 may work with the evaluation engine 136 to determine if one or more of the actions have succeeded, such as by accessing one or more sets of application data 172, assessment information 175, or test logs 178 created after the CAPA plan was initiated. The CAPA plan status manager 154 can update status information associated with one or more generated CAPA plans 127, either by updating the corresponding generated CAPA plan 127 with the current status information or by maintaining a separate file or document describing the status of the various actions. The regulatory manager 157 of the CAPA manager module 151 can be used to ensure that the various regulatory requirements for GMP and CAPA actions are followed, such as by providing an audit trail framework, a document management service, and e-signature capabilities, each of which may be generated and/or managed within memory 112 with the set of regulation required documents 130.

Returning to memory 112, memory 112 can store data and program instructions, including various information and data as described above, including the set of CAPA rules 115, the one or more system user lists 118, the set of root cause weighting information 121, the set of potential CAPA actions 124, the set of generated CAPA plans 127, and the set of regulation required documents 130, as well as any other CAPA or non-CAPA-related information. Memory 112 may include any memory or database module and may take the form of volatile or non-volatile memory including, without limitation, magnetic media, optical media, random access memory (RAM), read-only memory (ROM), removable media, or any other suitable local or remote memory component. Memory 112 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the CAPA system 103, its CAPA application 133, and the CAPA-related systems 160.

FIG. 1 further illustrates one or more CAPA-related systems 160. The CAPA-related systems 160 may include the systems monitored or associated with the CAPA system 103, for which the automated CAPA plan generation is provided. Each CAPA-related system 160 may be a system for performing one or more production and/or manufacturing operations associated with the development or creation of a product, good, or service associated with CAPA plans and regulatory monitoring and analysis. In general, the CAPA-related systems 160 can include various systems that are to conform to GMP guidelines in which compliance issues are monitored and could be identified.

Each CAPA-related system 160 may be any type of computing device or set of devices, as well as any appropriate system, including a server, client, distributed system, cloud-based system or network, or other suitable system. The example system 160 illustrated in FIG. 1 represents a server-based system, although alternative systems may be included. In general, each CAPA-related system 160 may store and execute one or more production applications 184, or a portion thereof. In other words, a particular CAPA-related system 160 may be associated with a production application 184, and perform only a portion of the operations and functionality associated therewith. In some instances, the CAPA system 103 and the CAPA-related system 160 may be included on a single system, server, or other computing device, as appropriate.

The CAPA-related system 160 is illustrated as including an interface 163, a processor 166, memory 169, and the production application 184. Interface 163, processor 166, and memory 169 may generally be similar to those described with regard to interface 106, processor 109, and memory 112 of the CAPA system 103, although each may be modified or different in particular implementations. As described with regard to the evaluation engine 136, memory 169 may store various information related to or associated with the production application 184 and/or the CAPA-related system 160, including assessment information 175 associated with one or more assessments performed by or on the CAPA-related system 160, test logs 178 generated in response to testing of a portion of the CAPA-related system 160, and survey results 181 completed by one or more users associated with the CAPA-related system 160 (either before or after an issue is detected or identified). Additionally, memory 169 may store other application data 172 directly associated with the production application 184. Processor 166 can execute the production application 184 and the proxy application 187. As previously described, the proxy application 187 can be a remote module of the CAPA application 133, used to collect data and information about the production application 184. The proxy application 187 can access the information stored in memory 169 associated with the production application 184, as well as information generated during the execution of the production application 184 in order to monitor for issues and other items of interest associated with the CAPA system 103.

Three particular sets of users are also illustrated in FIG. 1: an issue owner 193, one or more CAPA remediators 196, and one or more CAPA approvers 199. The issue owner 193 may be a user (or set of users) assigned as owner of a particular generated CAPA plan. The issue owner 193 may be an individual in charge or managing the process or processes with which a particular issue is identified or submitted. For example, if the identified issue is related to a particular manufacturing process, the issue owner 193 may be the manager or administrator of that manufacturing process. The issue owner 193 can assist the CAPA plan and performance by determining whether a particular issue is solved or remedied. In some instances, the issue owner 193 may submit an issue manually to the CAPA system 103 and CAPA application 133, while in others, the issue owner 193 may be identified based on one of the system user lists 118 by matching the production application 184 (or other system) with a manager or other user responsible for owning any identified issues.

The one or more CAPA remediators 196 includes one or more users associated with a particular process who are to be responsible for one or more of the corrective and/or preventive actions included in a generated CAPA plan. In some instances, the issue owner 193 may be one of the CAPA remediators 196. Once the set of corrective and/or preventive actions is determined for a particular issue and its CAPA plan, the system user lists 118 can be accessed to assign each action a corresponding user to perform the actions based on defined roles, process association, and other information included within the system user lists 118. In some instances, the issue owner 193 can modify the assigned CAPA remediators 196 after they are initially determined by the system (as described herein, the CAPA remediator assignment module 145). The one or more CAPA approvers 199 include one or more users reviewing the actions performed by the one or more CAPA remediators 196. The CAPA approvers 199 can be identified by the CAPA remediator assignment module 145, or the CAPA approvers 199 may be manually identified by the issue owner 193. In some instances, the issue owner 193 may also be a CAPA approver 199. CAPA approvers 199 may be assigned immediately when a CAPA remediator 196 is assigned to a particular task, while in other instances, CAPA approvers 199 may be manually assigned after a CAPA remediator 196 is assigned. In some instances, assignment of a particular CAPA approver 199 may be based on their management or supervisory roles with regard to a particular CAPA remediator 196. In other instances, the assignment of a particular CAPA approver 199 may be assigned based on the particular corrective and/or preventive action assigned, as opposed to the particular CAPA remediator 196 assigned. In still other instances, a combination of the two may be used, as well as other suitable determination factors.

Each of the users may be associated with one or more client systems. Each client system may be any computing device operable to connect to or communicate with at least one of the CAPA system 103, one or more of the CAPA-related systems 160, and/or one or more of the other client systems, either directly or via the network 190 using a wireline or wireless connection. Each client system can include a processor, an interface, a memory, and a graphical user interface (GUI) (not illustrated in FIG. 1). In general, each client system comprises an electronic computer device operable to receive, transmit, process, and store any appropriate data associated with the environment 100 of FIG. 1.

It will be understood that there may be any number of client systems associated with, or external to, environment 100. For example, while illustrated environment 100 includes three client systems (193, 196, 199), alternative implementations of environment 100 may include a more or less client systems communicably coupled to CAPA system 103 and/or one of the CAPA-related systems 160, or any other number of clients suitable to the purposes of the environment 100. Additionally, there may also be one or more additional clients systems external to the illustrated portion of environment 100 that are capable of interacting with the environment 100 via the network 190. Further, the term “client” and “user” may be used interchangeably as appropriate without departing from the scope of this disclosure. Moreover, while each client system is described in terms of being used by a single user, this disclosure contemplates that many users may use one computer, or that one user may use multiple computers.

The GUI associated with each client system can comprise a graphical user interface operable to, for example, allow the user of the client system to interface with at least a portion of the platform for any suitable purpose, such as creating, preparing, requesting, modifying, or analyzing data, as well as viewing and accessing documents and files associated with various business transactions. Generally, the GUI provides the particular user with an efficient and user-friendly presentation of business data provided by or communicated within the system. The GUI may comprise a plurality of customizable frames or views having interactive fields, pull-down lists, and buttons operated by the user. For example, the GUI may provide interactive elements that allow a user to enter or select elements of the CAPA application 133 or production application 184 in the GUI. Portions of various applications associated with either the CAPA system 103 or one of the CAPA-related systems 160 may be presented and accessible to the user through the GUI, such as through a web browser, for example. More generally, the GUI may also provide general interactive elements that allow a user to access and utilize various services and functions of a local application. The GUI is often configurable, supports a combination of tables and graphs (bar, line, pie, status dials, etc.), and is able to build real-time portals, where tabs are delineated by key characteristics (e.g. site or micro-site). Therefore, the GUI contemplates any suitable graphical user interface, such as a combination of a generic web browser, intelligent engine, and command line interface (CLI) that processes information in the platform and efficiently presents the results to the user visually.

As used in this disclosure, the client systems are intended to encompass personal computers, touch screen terminals, workstations, network computers, kiosks, wireless data ports, smart phones, personal data assistants (PDAs), one or more processors within these or other devices, or any other suitable processing device. For example, each client system may comprise a computer that includes an input device, such as a keypad, touch screen, mouse, or other device that can accept user information, and an output device that conveys information associated with the operation of the CAPA system 103 (and CAPA application 133), one or more of the CAPA-related systems 160 (and their respective production applications 184), or the client system itself, including digital data, visual information, and/or the GUI 198. Both the input and output device may include fixed or removable storage media such as a magnetic storage media, CD-ROM, or other suitable media to both receive input from and provide output to users of client system through the display, namely, the GUI.

While FIG. 1 is described as containing or being associated with a plurality of elements, not all elements illustrated within environment 100 of FIG. 1 may be utilized in each alternative implementation of the present disclosure. For example, although FIG. 1 depicts a CAPA system 103 external to the network 190, one or more servers or computers associated with CAPA system 103, as well as some or all of CAPA application 133, may be included within network 190 as part of a cloud network solution, for example. In some additional instances, the CAPA system 103 may be included within or local to one or more CAPA-related systems 160. Still further, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

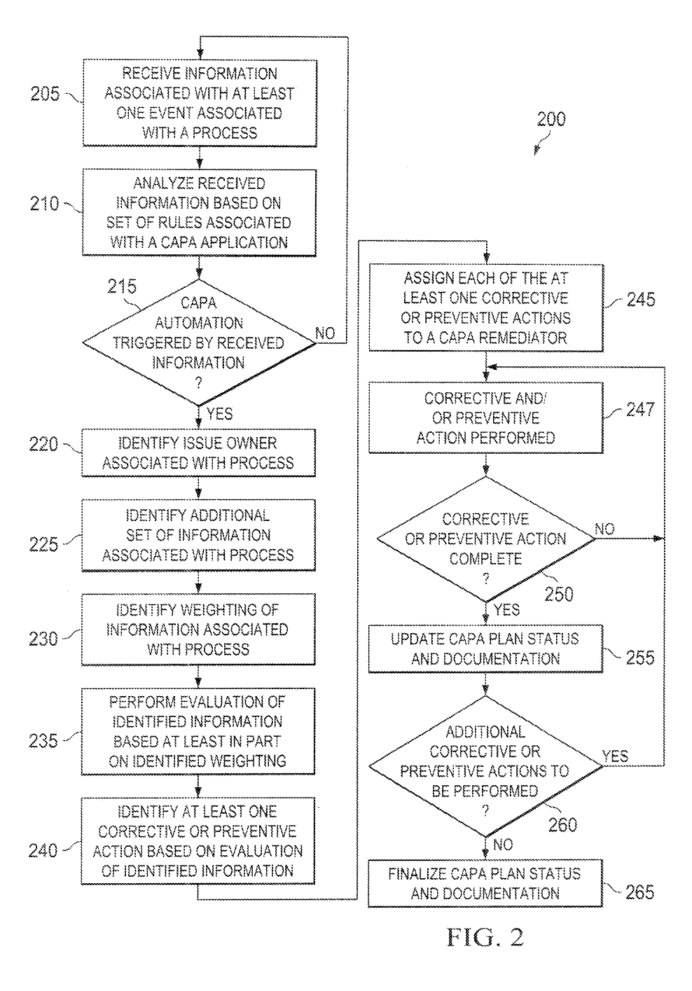

FIG. 2 is a flowchart of an example method 200 for automatically generating a CAPA plan and completing the actions associated therewith. For clarity of presentation, the description that follows generally describes method 200 in the context of environment 100 illustrated in FIG. 1 from the perspective of the CAPA system 103 used to generate a CAPA plan. However, it will be understood that method 200 may be performed, for example, by any other suitable system, environment, or combination of systems and environments, as appropriate.

At 205, information associated with at least one event associated with a business process is received. The business process may include a production or manufacturing process in a business system, such as a production system associated with CAPA system 103. The information may be provided from a production application, a manufacturing or production process, or another element of the production system. In other instances, the information may be received from a proxy application (such as proxy application 187 in FIG. 1) that collects and forwards the information to the CAPA system. In some instances, the proxy application may perform some preliminary analysis on the data, while in other instances, the proxy application may simply forward the data and information to the CAPA system.

At 210, the received information is analyzed based on a set of rules associated with a CAPA application. The rule set(s) used in the analysis of 210 may be selected from a plurality of rule sets stored at the CAPA system. In some instances, the origin from which the information is received may be used to determine which rules to apply. The selected rules may be used to determine if one or more issues have occurred within the originating system, and whether an automated CAPA process should be initiated. The determination as to whether the automated CAPA process should be initiated is determined at 215. In some instances, the received information may trigger the CAPA automation, and method 200 may continue at 215. In other instances, no CAPA process may be required based on the data, and method 200 returns to 205 as additional information is received. Various triggering events and analyses may cause a determination that an automated CAPA process should be started. In some instances, a manual triggering of the automated CAPA process may be received, such as an explicit indication from a user within the associated production system (i.e., from an issue owner 193). In other instances, if one or more issues are detected in the production system after the analysis is performed, or if certain thresholds are met, the automated CAPA process may be triggered. The rule sets may be configured by one or more administrators, such that a set of information in one system may trigger the automated CAPA process, while in other systems, the set of information will not trigger the automated CAPA process. The thresholds and analyses may be determined, at least in part, on one or more regulatory thresholds defined by a regulatory body and associated with the corresponding production system.

At 220, an issue owner associated with the process for which the CAPA automation is triggered is identified. Identifying an issue owner may include reviewing or accessing a set of system information to determine one or more users (or entities) associated with the process of the issue or triggering event that caused the CAPA automation to begin. At 225, an additional set of information associated with the process may be identified. The additional set of information (as well as the information received at 205) may include, but is not limited to, application data associated with the underlying process, as well as test logs, assessment data, and surveys associated therewith. In some instances, some or all of the additional information may be generated after the CAPA automation is triggered. For example, additional assessments, tests, or surveys may be performed after the CAPA automation process is begun after 215. In some instances, 225 may be optional, with the relevant information being retrieved or accessible after 205. At 230, a set of weighting information associated with the triggering process may be identified. In some instances, the weighting information may be included with the set of rules described at 210. The weighting information can be used to define the relative importance of particular information and data received at 205 and/or 225.

At 235, an evaluation of the identified information is performed, with the evaluation being based, at least in part, on the weighting information identified at 230. The evaluation may include a root cause analysis, a discrepancy analysis, or any other suitable analysis used to determine one or more causes of the triggering event or issue. This evaluation may be performed by the evaluation engine 136 illustrated in FIG. 1, or by any other suitable application or process. In some instances, more than one cause (or root cause) may be identified for a particular issue.

At 240, at least one corrective and/or preventive action is identified based on the evaluation of 235. In some instances, a set of potential corrective and/or preventive actions may be accessed by the CAPA application to determine one or more corrective and/or preventive actions associated with the determined causes of the underlying issue. In some instances, the identified issue owner may assist in the determination of the actions to be performed, either by adding or deleting one or more corrective and/or preventive actions initially determined by the automated process. Information defining the root cause analysis, as well as the identified set of corrective and preventive actions, may be combined into a single document or set of information to represent a generated CAPA plan. In some instances, the CAPA plan may not be complete until each of the identified actions is assigned to a particular user.

At 245, each of the identified corrective and/or preventive actions is assigned to one or more CAPA remediators. The one or more CAPA remediators can be determined based on the particular actions determined at 240. For example, if modifications to a particular process are to be performed as one of the corrective actions, a user associated with that process can be assigned as the CAPA remediator in charge of performing the respective action. While not illustrated in method 200, a CAPA approver can be assigned to each action, or to each CAPA remediator, as appropriate. The CAPA approvers can review the actions performed by each CAPA remediator to determine whether the actions were performed successfully.

For each corrective and preventive action assigned, a determination is made at 250 as to whether that action is complete. If the particular action is not complete, method 200 can remain at 250 until the action is complete. If the particular action is completed by the CAPA remediator, then method 200 continues to 255, where the status of the CAPA plan and the CAPA plan's associated documentation is updated. In some instances, the CAPA plan status and associated documentation can be managed by a CAPA plan manager or application, which can be accessed by the issue owner and other users to view, interact with, and update the CAPA plan. At 260, a determination is made as to whether additional corrective and/or preventive actions are to be performed, or are included in the CAPA plan. In some instances, the CAPA plan can be accessed within the CAPA plan manager to make this determination. If additional CAPA actions are to be performed, method 200 returns to 247, where the next CAPA action is performed. If no additional CAPA actions are to be performed, method 200 continues at 265, where the CAPA plan status and associated documentation is finalized. Finalizing the CAPA status plan may include issue owner approval and e-signing of CAPA documentation, as well as updating the CAPA plan status to “Final” within the CAPA plan manager. In some instances, finalizing the CAPA plan may include sending one or more notification messages or status updates to various users associated with the production system, the CAPA system, and/or the CAPA process, as well as individuals within the associated entity that are to be notified of the completion of the CAPA process.

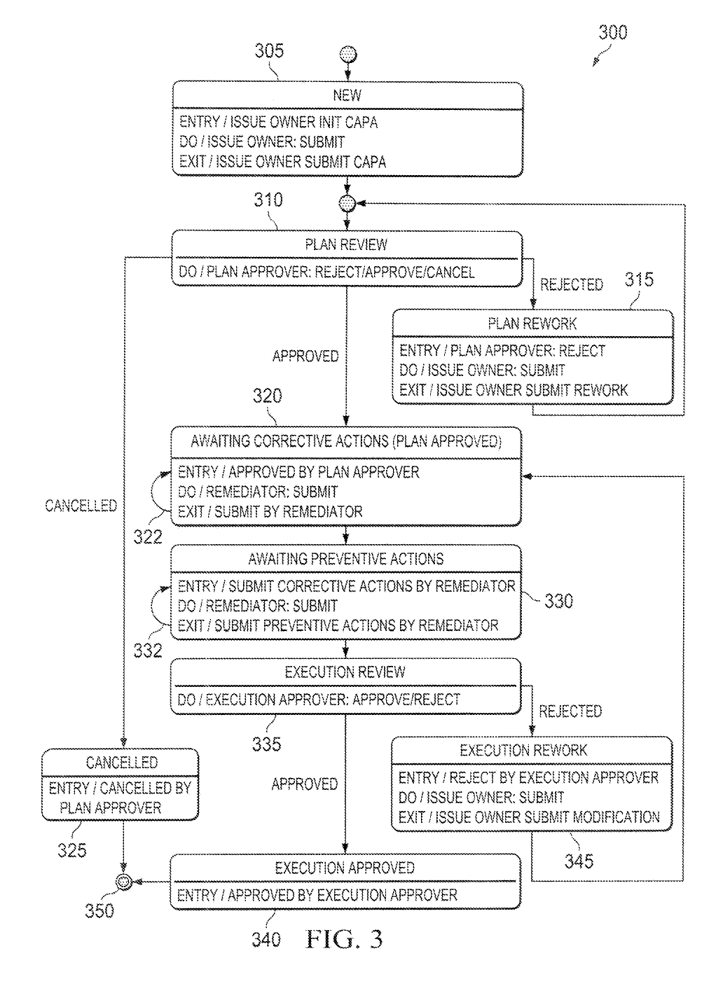

FIG. 3 is a flowchart of an example method 300 for executing an automatically generated CAPA plan by one or more users associated with the generated CAPA plan. It will be understood that method 300 may be performed, for example, by any other suitable system, environment, or combination of systems and environments, as appropriate.

At 305, information about an issue in a production or CAPA-related system is received. In the illustrated example of FIG. 3, a new issue is identified at 305. Further, the automated CAPA generation process (for example, the operations performed from 220-245 of FIG. 2), is performed at 305. In other words, a root cause analysis and CAPA action determination is performed based on information received from the issue owner, as well as information received and/or retrieved from the production system where the issue is occurring or has occurred. Once an automated CAPA plan is generated, the issue owner can submit the CAPA plan for initial approval at 310.

At 310, the CAPA plan is reviewed for approval, including a determination as to whether one or more modifications are to be made to the CAPA plan. The proposed CAPA plan can be reviewed by a single person or administrator, a regulatory manager, a group of administrators or executives, or any other appropriate entity. The reviewing entity is provided three options at 310: reject, approve, or cancel the submitted CAPA plan. If the plan is cancelled, method 300 moves to 325, where the plan status is changed to “Cancelled,” and the CAPA process is ended. If the plan is rejected, method 300 moves to 315, where the issue owner can rework the CAPA plan to remedy any deficiencies identified by the reviewing entity. Once the rejected CAPA plan is reworked at 315, method 300 moves back to 310, where the CAPA plan is reviewed again. If the CAPA plan is approved, either initially or after a reworking, method 300 continues at 320.

At 320, each of the set of corrective actions provided in the CAPA plan are performed by the CAPA remediators as assigned during the plan's development and/or reworking at 305/315 (i.e., in operation 245 of FIG. 2). In some instances, a single CAPA remediator may perform each of the corrective actions associated with a CAPA plan, while in others, the corrective actions may be assigned to two or more CAPA remediators. As illustrated by arrow 322, the entire set of corrective actions may be performed before the execution of the CAPA plan continues. Once each of the corrective actions is completed, method 300 continues at 330. At 330, each of the set of preventive actions included in the CAPA plan is performed by the assigned CAPA remediators. As illustrated by arrow 332, the entire set of preventive actions may be performed before the CAPA plan execution continues. In some instances, the execution of the corrective actions and the preventive actions may be performed concurrently, while in other instances, one or more of the preventive actions may be performed prior to the corrective actions. In some instances, the corrective actions may be required to be performed first in order to solve the outstanding issue prior to making any additional system changes associated with the preventive actions.

At 335, the execution of the various actions is reviewed by a CAPA approver. In some instances, each performed action may be individually reviewed by a CAPA approver. Additionally, each action may be reviewed by a different CAPA approver, or a set of CAPA approvers. In some instances, the performance of all CAPA actions may be reviewed by a single CAPA approver. At 335, the CAPA approver determines whether the individual action, set of actions, or entire set of actions is approved. If one or more of the actions are rejected, method 300 moves to 345, where the issue owner can address one or more of the rejected actions (either by reassigning the CAPA remediator, modifying the requirements or instructions associated with the action, or other reworking) before method 300 moves back to 320 and 330, where the rejected corrective and/or preventive actions are performed again or as modified by the associated CAPA remediators. If the CAPA plan execution is approved, method 300 continues at 340, where the CAPA plan status is confirmed as “Approved.” Any additional steps or operations associated with the finalization of the CAPA plan can be performed at 340. Once complete, method 300 ends at 350.

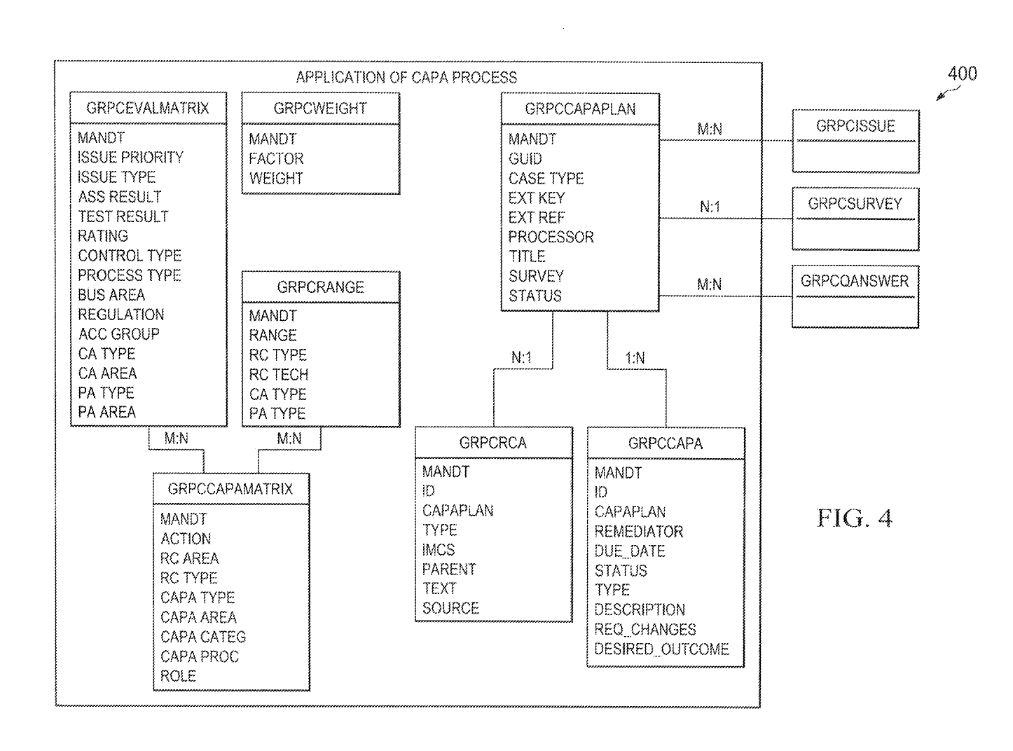

FIG. 4 is a data model 400 of database tables associated with an example implementation of an automatic CAPA generation system. The illustrated database tables can be included in or associated with a particular instance of a CAPA application, such as the instance of the CAPA application 133 illustrated in FIG. 1. One CAPA plan may involve many root causes and corrective and preventive actions. A CAPA plan can also include a survey, in which the questions associated with the survey need to be answered prior to, during, or after execution of the CAPA process. In some instances, the answers to the survey can be used to assist in the identification of the underlying causes of the issue. Other objects, including issues, assessments, and test logs, may be associated with the CAPA plan by a relation table.

The GRPCCAPAPLAN table includes general information associated with the CAPA plan, and may refer to one or more external business objects. The entry EXT REF refers to the business object and/or process for which the CAPA plan is created, such as an FDA control within the organization or entity associated with the CAPA plan. The entry STATUS refers to the current status of the CAPA plan. The entry SURVEY identifies the survey that the CAPA plan refers to.

The GRPCRCA table is for defining and identifying the root cause of the issue, including any immediate causes associated with the root cause. The IMCS entry defines one or more immediate causes with the identified root cause. The entry TYPE defines the type of the immediate cause. The entry PARENT represents the hierarchical parent to a particular immediate cause. The entry SOURCE represents source data for a particular cause. A plurality of root causes and immediate causes may be associated with a single issue.

The GRPCCAPA table includes information on the corrective and preventive actions included in a CAPA plan. The STATUS entry defines a status of a particular corrective or preventive action, such as whether the corrective or preventive action has been completed or not. The REQ_CHANGES entry defines the required changes associated with a particular corrective or preventive action, including the particular actions that are to be performed. The DESIRED_OUTCOME entry defines the expected and desired outcome as a result of the particular corrective or preventive action being performed. The REMEDIATOR entry defines the individual or entity responsible for the particular corrective or preventive action. A plurality of corrective and/or preventive actions can be associated with a particular CAPA plan.

The GRPEVALMATRIX table can be used by the evaluation engine to perform the automated evaluation and analysis described in the present disclosure. The different entries represent an example of the various factors considered by the evaluation engine in determining a root cause and identifying corrective and preventive actions while generating a CAPA plan. The entry ISSUE_PRIORITY identifies the priority of a received or identified issue. The entry ISSUE_TYPE identifies the type of the received or identified issue. The entry ASS_RESULT defines an assessment result. The entry TEST_RESULT defines a test result. The RATING entry defines an overall rating of the information associated with an issue. The CONTROL_TYPE entry defines a control type associated with the issue. The PROCESS_TYPE entry defines a business process type associated with the issue. The BUS_AREA entry defines the business area to which the associated control belongs. The REGULATION entry defines the type of regulation associated with the issue, such as FDA.

The GRPCWEIGHT table defines the weight assigned to each factor. The FACTOR entry defines a particular entry in the GRPEVALMATRIX table for generating a root cause analysis and a set of corrective and preventive actions. The WEIGHT entry defines a weight for each of the identified factors.

The GRPCRANGE table defines the root cause analysis and corrective and preventive action attributes that will be defined according to a particular value range. The RANGE entry defines a range for calculated values. The RC TYPE defines a particular root cause type. The RC TECH entry defines the techniques used by the root cause analysis to determine a particular root cause and/or immediate causes. The CA TYPE defines a corrective action type, and the PA TYPE defines a preventive action type.

The GRPCCAPAMATRIX tables defines relations between attributes of one or more corrective and preventive actions. The ACTION entry defines a particular corrective or preventive action. The RC TYPE entry defines a particular root cause type. The CAPA AREA entry defines a business area to which the corrective or preventive action belongs. The CAPA CATEG entry indicates a category for a particular corrective or preventive action. The CAPA PROC entry defines one or more stereotype procedures associated with a particular corrective or preventive action. The ROLE entry defines a default role for the action, such as the type of user or entity to perform the corresponding action.

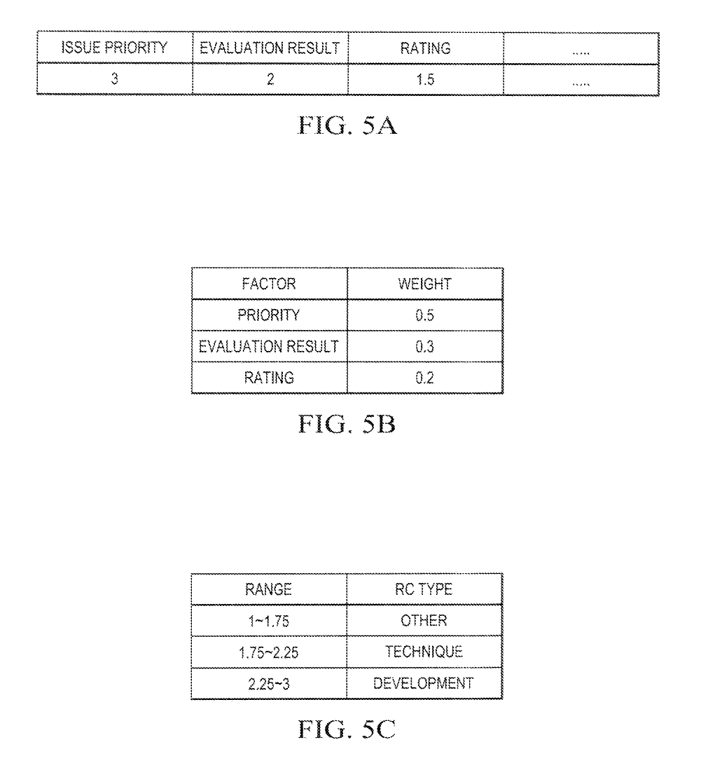

FIG. 4 represents an example data model 400 including the various tables used in a particular implementation of the CAPA application. Additional, fewer, and/or different tables and entries may be used in other implementations and examples. FIGS. 5A, 5B, and 5C illustrate example values in some of the tables and entries illustrated in FIG. 4 in a particular example. For example, a manager of an FD Internal Control can perform a manual test on Control CNTR_A of Organization ORG_A. After the manual test is performed, the tester of the process in which the control CNTR_A is assigned may be provided with the results. This individual may be considered the issue owner, or the tester can apply or identify the appropriate issue owner to manage the CAPA process. As illustrated in FIG. 5A, a set of information related to the issue is stored in the table GRPCEVALMATRIX, including an ISSUE_PRIORITY of 3, and EVA_RESULT (evaluation result) of 2, and a RATING of 1.5. Some or all of the other values for the table can also receive their corresponding values.

FIG. 5B illustrates the GRPCWEIGHT table and the corresponding weights applied to particular factors. The data in this table can be customized by a particular administrator, user, or entity based on particular business logic or reasoning, as well as for different scenarios and situations. In the illustrated table, the weight given to the PRIORITY factor is 0.5, the EVA_RESULT factor is 0.3, and the RATING is 0.2. The other factors will also be provided with a weight as defined for the entity. Finally, FIG. 5C illustrates a set of ranges used to define a particular root cause type. Here, a RANGE value of 1 to 1.75 will mean that the RC_TYPE is “Other,” a RANGE value of 1.75 to 2.25 will mean that the RC_TYPE is “Technique,” while a RANGE value of 2.25 to 3 will mean that the RC_TYPE is “Development.”

Based on the issue detail information that is received, as well as the customized data specific to the current scenario or situation, the evaluation engine can analyze the data and determine one or more root causes. In the present case, the determined value of the root cause is 2.40, which, when referring to the RANGE table, identifies the root cause type of the current issue as “Development.” The evaluation engine can call the corresponding model to “Development” in order to generate a root cause for the CAPA plan. The information received about an issue can be manually entered by a user or automatically received from one or more communicably coupled systems (as described in FIG. 1).

Once the root cause is identified, a corresponding set of corrective and preventive actions can be generated according to the information associated with the generated root cause. In some instances, the user can create and modify the data associated with the corrective and preventive actions manually. Once the root cause and corrective and preventive actions are created, the user can submit the CAPA plan for review and approval as described in FIG. 3. Once approved, the actions included and associated with the CAPA plan can be executed.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A computer-implemented method performed by one or more processors for automatically generating a corrective and preventive action (CAPA) plan, the method comprising the following operations:
receiving a notification of an identified issue in a manufacturing process from a proxy application executing at a business system, the proxy application operable to automatically identify issues at a production system based on business logic applied to business system-related data;
identifying, by at least one processor, a set of information associated with the identified issue, the set of information including a plurality of evaluation factors defining the identified issue;
identifying, by at least one processor, a set of weighting values associated with the identified issue, each of the set of weighting values associated with a particular evaluation factor, the set of weighting values stored in memory;
evaluating, by at least one processor, the identified issue based at least in part on the plurality of evaluation factors combined with the weighting value corresponding to each evaluation factor;
determining, by at least one processor, at least one root cause for the identified issue based on results of evaluating the evaluation factors with the weigh value corresponding to each evaluation factor;
identifying, by at least one processor, at least one corrective or preventive action from a corrective and preventive action repository based at least in part on the at least one determined root cause for the identified issue; and
automatically generating, by at least one processor, the CAPA plan for the identified issue, the CAPA plan including the at least one determined root cause and the at least one identified corrective or preventive action, wherein the CAPA plan is stored in memory.

2. (canceled)

3. The method of claim 1, wherein identifying the issue comprises receiving an issue notification submitted by a user associated with the business system.

4. The method of claim 1, wherein identifying the issue comprises:
receiving a set of information from a proxy application executing at the business system, the proxy application collecting and forwarding data associated with the business system's operation;
evaluating the received set of information from the proxy application to determine if an issue is occurring at the business system; and
continuing the automated generation of the CAPA plan if the issue is occurring at the business system.

5. The method of claim 1, wherein the set of information associated with the identified issue includes one or more of the following: raw application data associated with the business system, assessment data associated with the business system, test logs associated with the business system, and surveys completed by users of the business system.

6. The method of claim 1, wherein the set of weighting values comprises a plurality of sets of weighting values, each set of weighting values associated with one or more types of issue, and where identifying the set of weighting values associated with the identified issue further comprises:
determining an issue type of the identified issue; and
identifying the set of weighting values associated with the identified issue based on the determined issue type of the identified issue.

7. The method of claim 1, wherein automatically generating the CAPA plan for the identified issue includes, for each identified corrective and preventive action:
identifying a user associated with the business system to perform the particular corrective or preventive action; and
assigning the user to the particular corrective or preventive action.

8. The method of claim 1 further comprising the following operations:
receiving a notification of completion for each corrective or preventive action; and
updating the generated CAPA plan to reflect the completion status.

9. A computer program product encoded on a tangible storage medium, the product comprising computer readable instructions for causing one or more processors to perform operations comprising:
receiving a notification of an identified issue in a manufacturing process from a proxy application executing at a business system, the proxy application operable to automatically identify issues at a production system based on business logic applied to business system-related data;
identifying a set of information associated with the identified issue, the set of information including a plurality of evaluation factors defining the identified issue;
identifying a set of weighting values associated with the identified issue, each of the set of weighting values associated with a particular evaluation factor;
evaluating the identified issue based at least in part on the plurality of evaluation factors combined with the weighting value corresponding to each evaluation factor;
determining, by at least one processor, at least one root cause for the identified issue based on results of evaluating the evaluation factors with the weigh value corresponding to each evaluation factor;
identifying at least one corrective or preventive action based at least in part on the at least one determined root cause for the identified issue; and
automatically generating a CAPA plan for the identified issue, the CAPA plan including the at least one determined root cause and the at least one identified corrective or preventive action.

10. (canceled)

11. The computer program product of claim 9, wherein identifying the issue comprises receiving an issue notification submitted by a user associated with the production system.

12. The method computer program product of claim 9, wherein identifying the issue comprises:
receiving a set of information from a proxy application executing at the production system, the proxy application collecting and forwarding data associated with the production system's operation;
evaluating the received set of information from the proxy application to determine if an issue is occurring at the production system; and
continuing the automated generation of the CAPA plan if an issue is occurring at the production system.

13. The computer program product of claim 9, wherein the set of information associated with the identified issue includes one or more of the following: raw application data associated with the production system, assessment data associated with the production system, test logs associated with the production system, and surveys completed by users of the production system.

14. The computer program product of claim 9, wherein the set of weighting values comprises a plurality of sets of weighting values, each set of weighting values associated with one or more types of issue, and where identifying the set of weighting values associated with the identified issue further comprises:
determining an issue type of the identified issue; and
identifying the set of weighting values associated with the identified issue based on the determined issue type of the identified issue.

15. The computer program product of claim 9, wherein automatically generating the CAPA plan for the identified issue includes, for each identified corrective and preventive action:
identifying a user associated with the production system to perform the particular corrective or preventive action; and
assigning the user to the particular corrective or preventive action.

16. The computer program product of claim 9 further comprising the following operations:
receiving a notification of completion for each corrective or preventive action; and
updating the generated CAPA plan to reflect the completion status.

17. A system comprising:
memory operable to store information defining a set of root causes, a set of weighting values, and at least one or more corrective and preventive actions associated with at least one root cause; and
one or more processors operable to:
receive a notification of an identified issue in a manufacturing process from a proxy application executing at a business system, the proxy application operable to automatically identify issues at a production system based on business logic applied to business system-related data;
identify a set of information associated with the identified issue, the set of information including a plurality of evaluation factors defining the identified issue;
identify a set of weighting values associated with the identified issue, each of the set of weighting values associated with a particular evaluation factor;
evaluate the identified issue based at least in part on the plurality of evaluation factors combined with the weighting value corresponding to each evaluation factor;
determine, by at least one processor, at least one root cause for the identified issue based on results of evaluating the evaluation factors with the weigh value corresponding to each evaluation factor;
identify at least one corrective or preventive action based at least in part on the at least one determined root cause for the identified issue; and
automatically generate a CAPA plan for the identified issue, the CAPA plan including the at least one determined root cause and the at least one identified corrective or preventive action.

18. The system of claim 17, wherein the set of information associated with the identified issue includes one or more of the following: raw application data associated with the business system, assessment data associated with the business system, test logs associated with the business system, and surveys completed by users of the business system.

19. The system of claim 17, wherein the set of weighting values comprises a plurality of sets of weighting values, each set of weighting values associated with one or more types of issue, and where identifying a set of weighting values associated with the identified issue further comprises:
determining an issue type of the identified issue; and
identifying the set of weighting values associated with the identified issue based on the determined issue type of the identified issue.

20. The system of claim 17, wherein automatically generating a CAPA plan for the identified issue includes, for each identified corrective and preventive action:
identifying a user associated with the business system to perform the particular corrective or preventive action; and
assigning the user to the particular corrective or preventive action.
